(19) United States
(12) Patent Application Publication
(10) Pub. No.: US 2003/0172783 A1
(43) Pub. Date: Sep. 18, 2003

(54) Process for producing bundles of laminated sheet metal for magnet cores

(76) Inventor: Gunther Bausch, Vaihingen/Enz (DE)

Correspondence Address: Pauley Petersen Kinne & Erickson, Suite 365, 2800 W. Higgins Road, Hofffman Estates, IL, 60195, US

(21) Appl. No.: 10/339,661

(22) Filed: Jan. 9, 2003

(30) Foreign Application Priority Data
Jan. 10, 2002 (DE) 102 00 775.6-33

(51) Int. Cl. B26D 1/00

(52) U.S. Cl. 83/13; 83/651

(57) ABSTRACT

The invention relates to a process for producing bundles consisting of laminated sheet metal for magnet cores, wherein laminations are punched free along two longitudinal edges of a sheet metal strip, wherein at least two sheet metal laminations of a magnet core are of a different width extending from one longitudinal edge to the other, and wherein several laminations, which rest against each other, are connected with each other to form the bundle. To simplify the tool control it is provided in accordance with the invention that the two longitudinal edges of a lamination are punched in edge cutting stations, which are separate from each other and are arranged offset in the feed direction of the sheet metal strip, that the edge cutting stations for cutting the longitudinal edges have a cutting die and an associated bottom die, and that the cutting die, together with the bottom die, is displaced for creating different laminate widths.

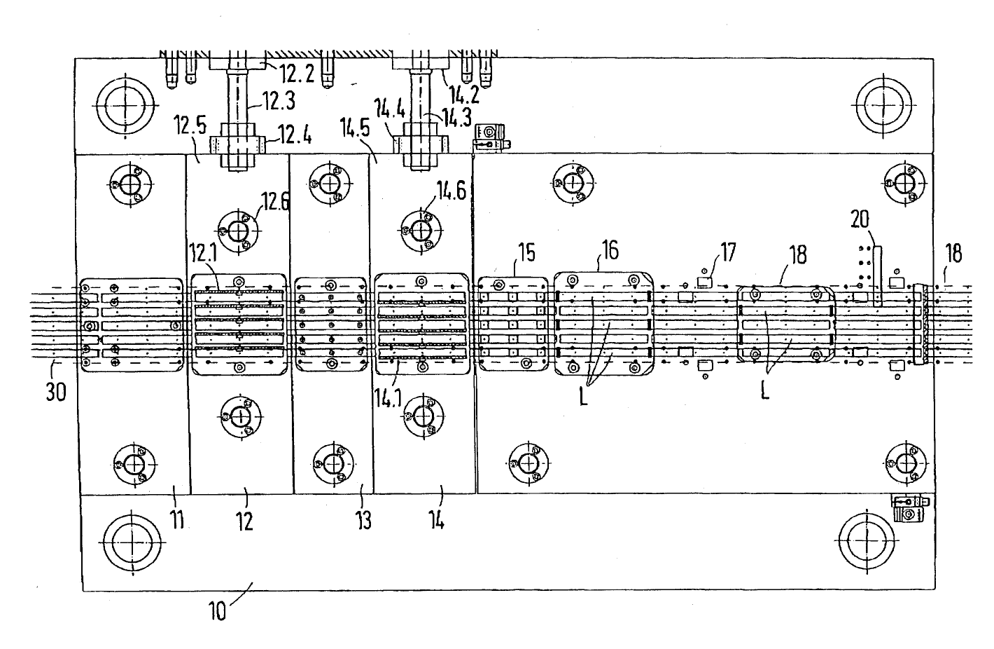

### FIELD OF THE INVENTION

The invention relates to a process for producing bundles consisting of laminated sheet metal for magnet cores, wherein laminations are punched free along two longitudinal edges of a sheet metal strip, wherein at least two laminations of a magnet core are of a different width extending from one longitudinal edge to the other, and wherein several laminations, which rest against each other, are connected with each other to form the bundle.

### BACKGROUND OF THE INVENTION

Such a process is known from DE 197 41 364 A1. Bundles made of sheet metal laminations are described there, which are employed in electromagnetic apparatus, for example impeders, transformers, drive mechanisms, etc.

Individual laminations are stamped out of a sheet metal strip and are stacked on top of each other. Connecting the laminations is performed by means of a known packing method. By means of the process described in DE 197 41 364 A1 it is intended to produce magnet cores of an approximately round cross section. For this purpose the width of the sheet metal laminations is varied. One or several sheet metal laminations with dimensions of the greatest width are positioned in the area of the center of the round cross section. For producing the geometry of the changing sheet metal laminations, a variable punching station is installed in a follow-on tool. It cuts the longitudinal edges of the sheet metal laminations. The cutting dies of this station can be adjusted, together with the bottom dies, by means of synchronous drive mechanisms.

A large control and positioning outlay is required, in particular in connection with tools in which several sheet metal laminations are to be punched in a single stroke.

### OBJECT AND SUMMARY OF THE INVENTION

It is the object of the invention to provide a process of the type mentioned at the outset, by means of which the production of the variable widths of the sheet metal laminations is possible with a reduced technical outlay for the tool and with a high degree of accuracy.

This object is attained in that the two longitudinal edges of a lamination are punched in edge cutting stations, which are separate from each other and are arranged offset in the feed direction of the sheet metal strip, that the edge cutting stations for cutting the longitudinal edges have a cutting die and an associated bottom die, and that the cutting die, together with the bottom die, is displaced for creating different lamination widths.

Because a separation of the working of the longitudinal edges is provided, the synchronization outlay for the exactly aligned displacement of the cutting dies and bottom dies is considerably reduced. It is possible in this way to realize a clearly simplified mechanical tool arrangement. In particular, this is also improved in that the cutting die is coupled with the bottom die, and they are displaced as a unit.

The fixed association of the cutting die and the bottom die makes an alignment of these two parts of the tools unnecessary.

The embodiment of the tools has been shown to be particularly advantageous if it is intended to process several laminations simultaneously in an edge cutting station. In this case the synchronization outlay is not at all, or only slightly, increased.

In accordance with a preferred embodiment variation of the invention it is provided that through-holes for the formation of sheet metal pieces are punched out of some of the laminations in a follow-on perforating device between the two edge cutting stations. The sheet metal separation pieces are used for separating the produced bundles.

For always providing an exactly fitting alignment of the sheet metal laminations in the various processing stations of the follow-on tool it can be provided that a follow-on perforating device is provided upstream of the edge cutting stations, in which locator perforations are punched out.

For combining the sheet metal laminations in the packing process it can be provided that in a stamping unit depressions are punched out of a predetermined number of laminations, which protrude in the form of nipples on the side of the sheet metal piece opposite the side with the depressions.

The nipples of a sheet metal lamination are then pressed into the depressions of the adjoining sheet metal lamination in the manner of a snap fastener. When using sheet metal separation pieces, the nipples of the end lamination are inserted into the through-holes of the sheet metal separation pieces.

For punching the sheet metal laminations completely out of the sheet metal strip it can be provided in accordance with a variation of the invention that the laminations are punched out of the sheet metal strip in the edge cutting stations of downstream-connected transverse stamping presses, wherein the transverse stamping presses each cut a transverse edge connecting the longitudinal edges.

The invention will be explained in greater detail in what follows by means of an exemplary embodiment represented in the drawings.

### BRIEF DESCRIPTION OF THE DRAWINGS

The single drawing represents a follow-on tool in horizontal section.

### DETAILED DESCRIPTION OF THE PREFERRED EMBODIMENT

The follow-on tool has a base plate 10 on which several processing stations have been installed. A sheet metal strip 30 is conducted through the processing stations, out of which sheet metal laminations are punched.

A follow-on perforating device 11 is arranged at the entry into the follow-on tool, which punches locator holes out of the sheet metal strip 30. These are subsequently used for positioning and aligning the sheet metal strip 30 in the follow-on stations. To this end, position pins engage the locator holes in each cycle of the machine. Following the follow-on perforating device 11, the sheet metal strip 30 reaches an edge cutting station 12. Here the longitudinal edges of the sheet metal laminations which are on the left in the feed direction are punched out. The edge cutting station has a lower bottom die support 12.5. An upper element is connected with it by means of guide columns 12.6. This upper element supports five punching dies 12.1. The upper element and the bottom die support 12.5 form a carriage which can be displaced transversely in respect to the feed direction of the sheet metal strip 30. The carriage is connected to a motor 12.2 via a coupling bearing 14.4 and an adjusting spindle 12.3. The carriage can be displaced by means of this drive mechanism. In this case the bottom die and the punching dies 12.1 are positioned, fixed in respect to each other, by means of the guide columns.

A follow-on perforating device 13 has been installed in the follow-on tool following the edge cutting station 12. The through-holes for the sheet metal separation pieces are punched out there. Since only one sheet metal separation piece is needed for each magnet core bundle, the hole-punching dies are activated via the packing control by means of a slide. An edge cutting station 14 is arranged following the follow-on perforating device 13. It is embodied substantially identical in respect to the edge cutting station 12. It can also be displaced transversely to the feed direction of the sheet metal strip 30. But it is employed for cutting the longitudinal edge of the sheet metal lamination which is to the right in the feed direction. To change the width of the sheet metal laminations it is only necessary to displace the carriages in opposite direction to each other.

A stamping unit 15 is arranged following the edge cutting station 14. It stamps depressions into one side of the sheet metal laminations. Corresponding to this, nipples are pushed out of the opposite side of the sheet metal lamination. The transverse edges, which connect the longitudinal edges, and therefore the sheet metal lamination L, are punched out in the transverse stamping presses 16 and 18. Braking magazines are arranged underneath the transverse stamping presses 16, 18. The sheet metal laminations can be pushed into these by means of the punching dies of the transverse stamping presses 16, 18. The required counterforce for pushing the sheet metal laminations with nipples into the depressions of the previous sheet metal laminations (packing) is generated by the braking effect in the braking magazines. As soon as the required number of sheet metal laminations has been stacked on top of each other, the sheet metal separation pieces are employed. Since these do not have nipples, no connection with the lamination underneath them takes place. In this way the sheet metal separation piece constitutes the first sheet metal lamination of the next magnet core bundle. The two transverse stamping presses are spatially separated from each other by means of an empty follow-on device 17.

Continuous monitoring takes place in a feed detection unit 20 for controlling the feeding of the follow-on tools.

The piece remaining of the sheet metal strip 30 is cut into individual pieces by means of a cutting device 19 at the end of the follow-on tool.

What is claimed is:

1. A process for producing bundles consisting of laminated sheet metal for magnet cores, wherein laminations are punched free along two longitudinal edges of a sheet metal strip, wherein at least two laminations of a magnet core are of a different width extending from one longitudinal edge to the other, and wherein several laminations, which rest against each other, are connected with each other to form the bundle,
characterized in that
the two longitudinal edges of a lamination are punched in edge cutting stations (12, 14), which are separate from each other and are arranged offset in the feed direction of the sheet metal strip (30),
the edge cutting stations for cutting the longitudinal edges have a cutting die (12.1) and an associated bottom die, and
the cutting die (12.1), together with the bottom die, is displaced for creating different laminate widths.

2. The process in accordance with claim 1,
characterized in that
the cutting die (12.1) is coupled with the bottom die and is combined with it to form a unit, and
this unit is displaced.

3. The process in accordance with claim 1 or 2,
characterized in that
the longitudinal edges of at least two laminations are cut in the edge cutting stations (12.1).

4. The process in accordance with one of claims 1 to 3,
characterized in that
through-holes for forming sheet metal separation pieces are punched out of some laminations in a follow-on perforating device (13) between the two edge cutting stations (12).

5. The process in accordance with one of claims 1 to 4,
characterized in that
a follow-on perforating device (11), in which locator holes are punched out, is installed upstream of the edge cutting stations (12.1).

6. The process in accordance with one of claims 1 to 5,
characterized in that
in a stamping unit (15) depressions are punched out of a predetermined number of laminations, which protrude in the form of nipples on the side of the sheet metal piece opposite the side with the depressions.

7. The process in accordance with one of claims 1 to 6,
characterized in that
the laminations are punched out of the sheet metal strip (30) in the edge cutting stations (12, 14) of downstream-connected transverse stamping presses (16), wherein the transverse stamping presses (16) each cut a transverse edge connecting the longitudinal edges.
